(19) United States
(12) Patent Application Publication
(10) Pub. No.: US 2026/0193083 A1
(43) Pub. Date: Jul. 9, 2026

(54) COMPOSITIONS AND PROCESSES FOR REMOVING HEAVY METALS FROM PHOSPHORIC ACID CONTAINING STREAMS

(71) Applicant: Cytec Industries Inc., Lawrence, NJ (US)

(72) Inventors: Ravi Rajshekar Hiremath, Milford, CT (US); Franklyn Ballentine, Stamford, CT (US); Lei Zhang, Stamford, CT (US); Michael Moser, Fairfield, CT (US); Joseph Calbick, Weston, CT (US); Kenan Tokmic, New Hope, PA (US)

(73) Assignee: Cytec Industries Inc., Lawrence, NJ (US)

(21) Appl. No.: 19/130,524

(22) PCT Filed: Nov. 17, 2023
(86) PCT No.: PCT/EP2023/082286

§ 371 Date: May 15, 2025

Related U.S. Application Data
(60) Provisional application No. 63/426,260, filed on Nov. 17, 2022.

(51) Int. Cl. C01B 25/238; C22B 3/38

(52) U.S. Cl. CPC C01B 25/238; C22B 3/3842; C22B 3/3846

(57) ABSTRACT

Compositions and processes for removing/recovering heavy metal ions in s phosphoric acid containing streams by adding reagents having at least one dialkyldithiophosphate compound, with the alkyl chain length of C8 to C18, at least one dialkyldithiophosphinate compound, and at least one surfactant to a phosphoric acid solution or slurry to form heavy metal ion complexes, and separating the heavy metal ion complexes from the solution or slurry are provided herein.

### FIELD OF THE INVENTION

The technological concept disclosed herein generally relates to purification of industrial process streams. More particularly, the concept disclosed herein relates to removing heavy metal ions, especially cadmium, arsenic and copper, from phosphoric acid containing streams.

### BACKGROUND

About 90% of the world's phosphoric acid is produced according to the wet process, which is conventionally prepared by acidulating phosphate rock (which contains calcium phosphate) with sulfuric acid to yield a crude wet-process phosphoric acid (WPA) and insoluble calcium sulfate (gypsum).

The manufacture of phosphoric acid is well known and is the subject of numerous textbooks. An overall view of the manufacture of phosphates and phosphoric acid is treated by Becker in Phosphates and Phosphoric Acids, Marcel Dekker, Inc. 1989, and by Stack in Phosphoric Acid, Part 1 and Part 2, Marcel Dekker, Inc. 1968. In the process, phosphate rocks are cleaned in the wash plant and ground in the ball mill before being fed into a series of reactors for digestion with sulfuric acid along with recycled phosphoric acid from the process. After digestion, the reaction slurry is filtered to separate phosphoric acid from undissolved rocks, the newly formed gypsum, and the gangues. The filtered, crude WPA is then sent to clarifiers and evaporators for further purification and concentration. Crude WPA can also be generated through digestion with nitric acid or hydrochloric acid

The purified phosphoric acid is either sent out as Merchant Grade Acid (MGA) or continued to make 69% P₂O₅ Super Phosphoric Acid (SPA), where it can be converted to many end products ranging from a chemical reagent, rust inhibitor, food additive, dental and orthopaedic etchant, electrolyte, flux, dispersing agent, industrial etchant, fertilizer feedstock, and component of home cleaning products. For example, crude phosphoric acid is concentrated to 54% (P₂O₅) before being sent for monoammonium phosphate (MAP), diammonium phosphate (DAP), or ammonium phosphate-sulfate (APS) production.

During the production of phosphoric acid, certain metal impurities in the form of heavy metal ions, such as cadmium (Cd), arsenic (As), lead (Pb), copper (Cu), and mercury (Hg), are present as minerals in the phosphate rock and are dissolved into the phosphoric acid. Depending on the application of the phosphoric acid, the metal impurities above a certain level are considered unacceptable because of their toxicity. Accordingly, the metal impurities have to be either completely removed or their levels in the phosphoric acid have to be significantly reduced.

For example, cadmium (Cd) is toxic and can cause multiple health issues to human. Studies show that the major exposure of Cd to nonsmoking general population is through ingestion of contaminated food. Phosphate fertilizers have been identified as an important source that introduces Cd to the soil, which can be easily absorbed by agricultural plants and accumulated into the food chain (“Cadmium in phosphate fertilizers; ecological and economical aspects”, CHEMIK 2014, 68, 10, 837-842).

Cd in phosphate fertilizer comes from phosphoric acid, the major raw material used to produce phosphate fertilizer. In fact, the majority of phosphoric acid production is used to produce fertilizer. Cd in phosphoric acid further stems from the phosphate bearing ores. Therefore, Cd can be removed either from the phosphate ore or from the phosphoric acid stream, with the latter being the focus of research in the past decades. Several categories of technologies to remove Cd from acid stream have been developed, including co-crystallization with anhydrite, precipitation with sulfide ions and organic sulfurous compounds, removal by solvent extraction, removal by ion exchange, removal by adsorbents, and separation by membrane technology (“Progress in the development of decadmiation of phosphorus fertilizers” Fertilizer Industry Federation of Australia, Inc., Conference “Fertilizers in Focus”, 2001, 101-106).

U.S. Pat. No. 4,378,340 (1983) describes a method of removing heavy metals, particularly cadmium, from wet process phosphoric acid through partial neutralization of acids with alkali, followed by precipitation with sulfide compounds. U.S. Pat. No. 5,431,895 (1995) also discloses using alkali solution and aqueous sulfide solution simultaneously with thorough mixing to remove lead and cadmium from phosphoric acid.

U.S. Pat. No. 4,986,970 (1991) discloses using metal salt of dithio carbonic acid-O-esters to precipitate the heavy metals, especially cadmium, from partially neutralized (pH 1.4-2) and pre-cooled (5-40° C.) phosphoric acid. Afterwards, the complexes can be separated from the acid using methods like flotation or filtration.

U.S. Pat. No. 4,452,768 (1984), U.S. Pat. No. 4,479,924 (1984), U.S. Pat. No. 4,713,229 (1987), and European Patent No. EP0333489 Bi (1989) describes methods of separating heavy metals, especially cadmium, mercury, and lead, from phosphoric acid using a diorganyldithiophosphoric acid ester and an adsorbent, a diorganyldithiophosphorus compound and an adsorbent, a diorganyldithiophosphoric acid ester and an adsorbent and a reductant, and a thioorganophosphine reagent and a reducing agent, respectively.

U.S. Patent Publication No. 2004/0179984 also discloses methods of removing heavy metals from wet process phosphoric acid by adding a mixture reagents of diorgano dithiophosphinic acid (or alkali metal or ammonia salts thereof), a first dithiophosphoric acid (or alkali metal or ammonia salts thereof) with alkyl or alkylaryl or aralkyl moieties, and optionally a second diaryl dithiophosphoric acid (or alkali metal or ammonia salts thereof).

Several scientific publications (“Cadmium(II) extraction from phosphoric media by bis(2,4,4-trimethylpentyl) thiophosphinic acid (Cyanex 302),” Fluid Phase Equilibria 145 (1998) 301-310), and “Extraction of cadmium from phosphoric acid by trioctylphosphine oxide/kerosene solvent using factorial design,” Periodica Polytechnic Chemical Engineering 55/2 (2011) 45-48)) discuss removal of Cadmium from phosphoric acid based on solvent extraction method using reagents such as bis(2,4,4-trimethylpentyl) thiophosphinic acid/kerosene, and trioctylphosphine oxide/kerosene, respectively.

However, while the various reagents and approaches discussed above may have some merits and applicability in phosphoric acid production, the high investment cost, high treatment cost, and low efficacy are limiting their wide acceptance at the plant scale (See “Cadmium in phosphate fertilizers; ecological and economical aspects”, CHEMIK 2014, 68, 10, 837-842). Heavy metal contamination of food, especially cadmium that stems from use of phosphoric acid in fertilizer production, continues to be a concern to public health. The economic impact for the issue of heavy metal is substantial, and the industry is in need of a more efficient and economical technology than that which currently exists. Additionally, there has been a recent regulatory push to further limit the Cd level in phosphate fertilizers (See European Commission Fact Sheet. “Circular economy: New Regulation to boost the use of organic and waste-based fertilisers.” EU MEMO-16-826, 17 Mar. 2016, europa.eu/rapid/press-release_MEMO-16-826_en.htm).

In an effort to address such regulatory hurdles, U.S. Pat. No. 10,865,110 (2020) to Applicant provides processes for removing heavy metal ions such as cadmium and arsenic from phosphoric acid solutions containing such heavy metal ions by adding an effective amount of a reagent including an organothiophosphorus compound and a surfactant to the phosphoric acid solution. Once the reagent forms a heavy metal complex, it can be separated from the phosphoric acid solution by any means known to those skilled in the art. While this process is very effective, it tends to require a high dosage of organothiophosphorus reagent for phosphoric acid solutions containing increased levels of cadmium.

However, despite these efforts, there remains an important issue that these different solutions do not resolve. Indeed, the question of the operators' health who are next to the acid stream is pending, and, in particular, by the fact that they can be subjected to the off-gassing of H₂S, when processes for removing heavy metal ions are implemented.

Accordingly, the compositions and methods presently available for heavy metal removal from phosphoric acid in the production process require further and/or continuous improvement. Since many factors (e.g., ore type, temperature, agitation, reactor design, acid chemistry, foreign ions, organic species, and viscosity of phosphoric acid medium) can affect the performance of reagents, it is a great challenge to develop high-efficiency reagents useful for removing heavy metals from phosphoric acid and reducing the safety risk to operators next to the acid stream. Successful reagents for removing heavy metals in industrial process streams such as wet process phosphoric acid would be a useful advance in the art and could find rapid acceptance in the industry.

### SUMMARY

The foregoing and additional objects are attained in accordance with the principles of the invention wherein the inventors detail the surprising discovery that at least one dialkyldithiophosphate compound, with the alkyl chain length of C8 to C18, at least one dialkyldithiophosphinate compound, and at least one surfactant are effective as a new reagent composition for removing heavy metal ions from phosphoric acid containing streams and that said new reagent composition makes it possible to significantly reduce the off-gassing of H₂S when treating phosphoric acid containing streams with this composition than with the widely-used benchmark products in the market. Accordingly, the processes for removing heavy metal ions according to various embodiments of the present invention as described herein below are applicable for use with the various stages of wet process phosphoric acid production.

Accordingly, in one aspect the present invention provides compositions for complexing heavy metals in solution, wherein the composition comprises an effective amount of at least one dialkyldithiophosphate compound, with the alkyl chain length of C8 to C18, at least one dialkyldithiophosphinate, and at least one surfactant.

In another aspect, the invention provides processes for removing heavy metal ions from a solution containing phosphoric acid by adding an effective amount of a reagent comprising at least one dialkyldithiophosphate compound, with the alkyl chain length of C8 to C18, at least one dialkyldithiophosphinate compound, and at least one surfactant to the solution to form heavy metal complexes and separating the heavy metal complexes from the solution.

In the same or additional embodiments, the process can further comprise adding an effective amount of a reducing agent to the solution containing phosphoric acid.

In the same or additional embodiments, the process can further comprise adding an effective amount of an adsorbent to the solution containing phosphoric acid.

This summary of the invention does not list all necessary characteristics and, therefore, subcombinations of these characteristics or elements may also constitute an invention. Accordingly, these and other objects, features and advantages of this invention will become apparent from the following detailed description of the various aspects of the invention taken in conjunction with the accompanying Figures and Examples.

### BRIEF DESCRIPTION OF THE DRAWINGS

FIG. 1 is a graph illustrating the results of Examples 2A-1 to 2A-9 wherein, the percentage of cadmium removed from the plant phosphoric acid #1 (54% P₂O₅) at ~72° C. with dose of various reagent at 3 kg/T P₂O₅ level,

FIG. 2 is a graph illustrating the results of Examples 3A-1 to 3A-7 wherein, the percentage of cadmium, arsenic and copper removed from the plant phosphoric acid #2 (60% P₂O₅) at ~72° C. with dose of various reagent at 3 kg/T P₂O₅ level,

FIG. 3 is a graph illustrating the results of Examples 4A to 4P wherein, the concentration of H₂S in the head space above the plant phosphoric acid #3 (30% P₂O₅), is measured directly following the procedure described below, with dosages of various reagent at 2 kg/T P₂O₅ level.

### DETAILED DESCRIPTION

The present disclosure generally relates to purification of solutions in industrial process streams. More particularly, the inventors describe herein for the first time reagents and processes for removing and/or recovering heavy metal ions from phosphoric acid containing streams by adding an effective amount at least one dialkyldithiophosphate compound with the alkyl chain length of C8 to C18, at least one dialkyldithiophosphinate compound, and at least one surfactant to form a heavy metal complex, and separating the complex from the solution. The compositions and processes described herein provide improvement and/or an unexpected advantage when compared to compositions and processes of the prior art.

As employed throughout the present disclosure, the following terms are provided to assist the reader. Unless otherwise defined, all terms of art, notations and other scientific or industrial terms or terminology used herein are intended to have the meanings commonly understood by those of skill in the chemical and/or phosphoric acid production arts. In some cases, terms with commonly understood meanings are defined herein for clarity and/or for ready reference, and the inclusion of such definitions herein should not necessarily be construed to represent a substantial difference over the definition of the term as generally understood in the art unless otherwise indicated. As used herein and in the appended claims, the singular forms include plural referents unless the context clearly dictates otherwise. Throughout this specification, the terms retain their definitions.

As used herein with reference to the present invention, the term “heavy metal” or “metal” shall refer to those elements of the periodic table having a density of more than 5 g/cm³ and an oxidation state higher than 0, (i.e., heavy metal ions). Such heavy metal ions include, for example, one or more of, cadmium, chromium, arsenic, nickel, mercury, zinc, manganese, titanium, copper and lead. In any or all embodiments, cadmium ions are removed from phosphoric acid containing streams. In the same or alternate embodiments, arsenic ions are removed from phosphoric acid containing streams.

The concept of “heavy metal complex” refers to compounds formed by reacting heavy metal ions with chelating agents. Heavy metal complexes can be solid, waxy, or oily in the phosphoric acid solutions. They can precipitate, float, or suspend in the phosphoric acid solutions.

Those skilled in the art will understand that reference to “phosphoric acid containing streams”, or “phosphoric acid solutions,” or “solutions containing phosphoric acid,” in the context of the invention includes any acidic solution containing crude phosphoric acid, digestion slurries of phosphoric acid, filtered phosphoric acid, and/or concentrated phosphoric acid. Such phosphoric acid containing streams are typically obtained from industrial phosphoric acid production plant streams.

“Effective amount” means the dosage of any reagents on an active basis (such as the compositions comprising at least one dialkyldithiophosphate compound with the alkyl chain length of C8 to C18, at least one dialkyldithiophosphinate compound, and at least one surfactant described herein) necessary to provide the desired performance in the phosphoric acid system or circuit being treated (such as the formation of heavy metal complexes) when compared to an untreated control system or system using a reagent product of the prior art.

As used herein, the term “alkyl” is intended to include linear, branched, or cyclic hydrocarbon structures and combinations thereof. Preferred alkyl groups are those of C30 or below. Lower alkyl refers to alkyl groups of from 1 to 6 carbon atoms. Examples of lower alkyl groups include methyl, ethyl, propyl, isopropyl, butyl, s- and t-butyl, pentyl, hexyl and the like. Cycloalkyl is a subset of alkyl and includes cyclic hydrocarbon groups having from 3 to 30 carbon atoms, preferably from 3 to 8 carbon atoms as well as polycyclic hydrocarbons having 7 to 10 carbon atoms.

The term “aryl” as used herein refers to cyclic aromatic hydrocarbons that do not contain heteroatoms in the ring. In any or all embodiments, aryl groups contain about 6 to about 14 carbons in the ring portions of the groups. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those known to persons of skill in the art. Aryl groups of C6-C12 are preferred.

The term “alkaryl” as used herein is a broad term and is used in its ordinary sense, including, without limitation, to refer to an aryl having at least one aryl hydrogen atom replaced with an alkyl moiety. The term “aralkyl” as used herein is a broad term and is used in its ordinary sense, including, without limitation, to refer to an alkyl having at least one alkyl hydrogen atom replaced with an aryl moiety, such as benzyl, —CH₂(1 or 2-naphthyl), —(CH₂)₂phenyl, —(CH₂)₃phenyl, —CH(phenyl)₂, and the like. Particularly preferred are C₇₋₂₀ aralkyl groups.

The terms “comprised of,” “comprising,” or “comprises” as used herein includes embodiments “consisting essentially of” or “consisting of” the listed elements, and the terms “including” or “having” in context of describing the invention should be equated with “comprising”.

Those skilled in the art will appreciate that while preferred embodiments are discussed in more detail below, multiple embodiments of the reagent system and processes described herein are contemplated as being within the scope of the present invention. Thus, it should be noted that any feature described with respect to one aspect or one embodiment of the invention is interchangeable and/or combinable with another aspect or embodiment of the invention unless otherwise stated. It will also be understood by those skilled in the art that any description of the invention, even though described in relation to a specific embodiment or drawing, is applicable to and interchangeable with other embodiments of the invention.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group consisting of any two or more of the explicitly listed elements, components, or features. Additionally, any element, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. The term “et seq.” is sometimes used to denote the numbers subsumed within the recited range without explicitly reciting all the numbers, and should be considered a full disclosure of all the numbers in the range. Disclosure of a narrower range or more specific group in addition to a broader range or larger group is not a disclaimer of the broader range or larger group.

The dialkyldithiophosphate compounds with the alkyl chain length of C8 to C18, described herein for any or all embodiments, comprise dialkyldithiophosphoric acid with the alkyl chain length of C8 to C18 and any salts (e.g., calcium, magnesium, potassium, sodium, ammonium salt with the formula NR₁R₂R₃R₄⁺, where R₁, R₂, R₃, R₄ are, equal to or different from each other, independently chosen from hydrogen, alkyl or aryl groups) of any of the foregoing dialkyldithiophosphoric acid with the alkyl chain length of C8 to C18; and mixtures thereof. In some embodiments, the alkyl chain of the dialkyldithiophosphate compound according to the invention is C8 to C12. Preferably, the alkyl chain of the dialkyldithiophosphate compound according to the invention is a C8 alkyl chain.

In the same or alternate embodiments, the dialkyldithiophosphate compound is selected from the group consisting of any salts of di(1,3-dimethylbutyl) dithiophosphoric acid, di(2-ethylhexyl) dithiophosphoric acid, di(3,7-dimethyloctyl) dithiophosphoric acid, di(2-butyloctanol) dithiophosphoric acid; and mixtures thereof. In a preferred embodiment, dialkyldithiophosphate compound are salts of di(2-ethylhexyl) dithiophosphoric acid, di(3,7-dimethyloctyl) dithiophosphoric acid, and di(2-butyloctanol) dithiophosphoric acid; and mixtures thereof. In a more preferred embodiment, the dialkyldithiophosphate compound is salts of di(2-ethylhexyl) dithiophosphoric acid, preferably ammonium salt of di(2-ethylhexyl) dithiophosphoric acid.

In the same or alternate embodiments, the dialkyldithiophosphate compound is selected from the group consisting of di(1,3-dimethylbutyl) dithiophosphate, di(2-ethylhexyl) dithiophosphate, di(3,7-dimethyloctyl) dithiophosphate, di(2-butyloctanol) dithiophosphate; and mixtures thereof. In a preferred embodiment, dialkyldithiophosphate compound are di(2-ethylhexyl) dithiophosphate, di(3,7-dimethyloctyl) dithiophosphate, and di(2-butyloctanol) dithiophosphate; and mixtures thereof. In a more preferred embodiment, the dialkyldithiophosphate compound is di(2-ethylhexyl) dithiophosphate.

Preferably, the dialkyldithiophosphate compound is ammonium di(2-ethylhexyl) dithiophosphate.

The dialkyldithiophosphinate compound described herein for any or all embodiments comprise dialkyldithiophosphinic acid and any salts (e.g., calcium, magnesium, potassium, sodium, ammonium salt with the formula NR₁R₂R₃R₄⁺, where R₁, R₂, R₃, R₄ are, equal to or different from each other, independently chosen from hydrogen, alkyl or aryl groups) of the foregoing dialkyldithiophosphinic acid; and mixtures thereof.

In the same or alternate embodiments, the dialkyldithiophosphinate compound is selected from the group consisting of any salts of diisobutyl dithiophosphinic acid; bis(2,4,4-trimethylpentyl) dithiophosphinic acid; and mixtures thereof. In a preferred embodiment, the dialkyldithiophosphinate compound is sodium diisobutyl dithiophosphinate.

In any or all embodiments the surfactant compound can be selected from the group consisting of sulfosuccinates; aryl sulfonates; alkaryl sulfonates; diphenyl sulfonates; olefin sulfonates; sulfonates of ethoxylated alcohols; petroleum sulfonates; sulfosuccinamates; alkoxylated surfactants; ester/amide surfactants; EO/PO block copolymers (ethylene oxide/propylene oxide); and mixtures thereof. In the same or alternate embodiment, the surfactant can be an alkaryl sulfonates. In a preferred embodiment, the surfactant can be an alkyldiphenyloxide disulfonate. Suitable alkyldiphenyloxide disulfonate compounds include, but are not limited to, DOWFAX® 8390 available from Dow Chemical.

In the same or alternate embodiment, the surfactant can be a sulfosuccinate. Suitable sulfosuccinate can be sodium dioctylsulfosuccinate. Suitable sodium dioctylsulfosuccinate compounds include, but are not limited to, AEROSOL® OT-70 and DHAYSULF® 70B available from Solvay S.A.

In the same or alternate embodiment, the surfactant can be an alkoxylated surfactant. Suitable alkoxylated surfactants can include, but are not limited to, polyethyleneglycol sorbitan monooleate (such as TWEEN® 80 available from Croda), and polyethyleneglycol sorbitol hexaoleate (such as ATLAS® G1086 available from Croda).

In any or all embodiments of the invention, the at least one dialkyldithiophosphate compound with the alkyl chain length of C8 to C18, at least one dialkyldithiophosphinate compound, and at least one surfactant can be added to either the crude phosphoric acid or digestion slurries prior to gypsum filtration, or to the filtered phosphoric acid or to the concentrated phosphoric acid to complex the heavy metal ions. Afterwards, heavy metal complexes so formed can be separated from the phosphoric acid or slurry. Separation may be carried out via any suitable method known in the art for such separation. In any or all embodiments, the methods of separation include, but are not limited to, filtration, centrifugation, sedimentation, creaming, skimming, flocculation, adsorption, and/or flotation.

In any or all embodiments of the invention, the at least one dialkyldithiophosphate compound with the alkyl chain length of C8 to C18, at least one dialkyldithiophosphinate compound, and at least one surfactant can be added to the solution containing phosphoric acid all in one stage or added in several stages. In the same or other embodiments, the at least one dialkyldithiophosphate compound with the alkyl chain length of C8 to C18, at least one dialkyldithiophosphinate compound, and at least one surfactant is added as a blend, or separately in any order such as concurrently together or sequentially. In a preferred embodiment, the at least one dialkyldithiophosphate compound with the alkyl chain length of C8 to C18, at least one dialkyldithiophosphinate compound, and at least one surfactant is added as a blend.

Treatment times in any or all embodiments of the invention can be from a few seconds (i.e., 5 to 10 seconds) to 240 minutes. In those instances where the reagent complexes the heavy metals very rapidly, the preferred treatment times are from about 5 seconds to 5 minutes. Most typically, the treatment times are from 10 seconds to 60 seconds or 120 seconds.

The dosage of the reagent for complexing heavy metals and removal efficiency for the various heavy metals will depend on the amount of heavy metal impurities present in the ore and/or phosphoric acid containing streams. Generally, the greater number of heavy metals present and the higher their concentrations, the greater will be the overall dosage of the reagent. Those skilled in the art will be able to readily determine and establish the optimum dosage of at least one dialkyldithiophosphate compound with the alkyl chain length of C8 to C18, at least one dialkyldithiophosphinate compound, and at least one surfactant required using no more than routine experimentation. Generally, the dosages may be in the range of from 0.01 to 50 kg (e.g., 0.01, 0.02, 0.03, 0.04, 0.05, et seq. to 0.10, 0.15, 0.20, 0.25, 0.30, et seq. to 1.0, 1.5, 2.0, 2.5, 3.0, 3.5, 4.0, 4.5, 5.0, et seq. to 10, 15, 20, 25, 30, 35, 40, 45, 50 kg) reagent per ton of P₂O₅ of the phosphoric acid solution, based on the type of heavy metal ions to be removed. Most typically, the dosages can be from 0.1 kg to 10 kg (e.g., 0.10, 0.15, 0.20, 0.25, 0.30, et seq. to 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, and 10 kg) of reagent per ton of P₂O₅. It will be understood by those ordinary skilled in the art that any of the recited dosages (except the lowest dosage point) can also be recited as “less than” a particular dosage, e.g., less than 50 kg; or that any of the recited dosages (except the highest dosage point) can also be recited as “greater than” a particular dosage, e.g., greater than 0.10 kg.

The ratio of the sum of at least one dialkyldithiophosphate compound with the alkyl chain length of C8 to C18 and at least one dialkyldithiophosphinate compound to surfactant is from 1000:1 to 5:1. In a preferred embodiment, the ratio of the sum of at least one dialkyldithiophosphate compound with the alkyl chain length of C8 to C18 and at least one dialkyldithiophosphinate compound to surfactant is from 100:1 to 10:1.

In any or all embodiments, the ratio of at least one dialkyldithiophosphate compound with the alkyl chain length of C8 to C18 to at least one dialkyldithiophosphinate compound is from 1:100 to 100:1. In a preferred embodiment, the ratio of at least one dialkyldithiophosphate compound with the alkyl chain length of C8 to C18 to at least one dialkyldithiophosphinate compound is from 1:20 to 20:1. In a more preferred embodiment, the ratio of at least one dialkyldithiophosphate compound with the alkyl chain length of C8 to C18 to at least one dialkyldithiophosphinate compound is from 1:5 to 5:1.

In any or all embodiments, the solution containing phosphoric acid has a P₂O₅ concentration from 4 wt. % to 70 wt. %, typically from 25 wt. % to 60 wt. %. Specific concentrations of P₂O₅ contemplated for use with the invention include 25 wt. %, 28 wt. %, 30 wt. %, 42 wt. %, 44 wt. %, 52 wt. %, 54 wt. %, 57 wt. %, and 60 wt. %.

The compositions and processes described herewith as the present invention can be used over a wide temperature range. In any or all embodiments, for example, the processes according to the invention can be performed at a temperature from 0° C. to 120° C. Preferably, the temperature is in the range from 20° C. to 80° C.

In any or all of the embodiments according to the present invention, the process can further comprise adding an effective amount of a reducing agent and/or an adsorbent to the solution containing phosphoric acid. Such agents are known to be useful in the field. In certain circumstances one or both of these agents can enhance the activity of the reagent including the at least one dialkyldithiophosphate compound with the alkyl chain length of C8 to C18, at least one dialkyldithiophosphinate compound, and at least one surfactant. In the same or alternate embodiments, the reducing and/or adsorbent agent can be added to the phosphoric acid containing streams all in one stage or added in several stages. In the same or other embodiments, the reducing and/or adsorbent agent can be added together as a blend with the reagent including the at least one dialkyldithiophosphate compound with the alkyl chain length of C8 to C18, at least one dialkyldithiophosphinate compound, and at least one surfactant, or separately in any order with the at least one dialkyldithiophosphate compound with the alkyl chain length of C8 to C18, at least one dialkyldithiophosphinate compound, and at least one surfactant such as concurrently together or sequentially. While the nature and quantity of the reducing and/or adsorbent agents used depends on the particular composition of the phosphoric acid in the solution, and of the purity specifications, those skilled in the art will be able to determine the optimum dosage range using no more than routine experimentation.

Reducing agents useful in any or all processes according to the invention include, but are not limited to, iron powder, zinc, red phosphorus, iron (II) sulfate, sodium hypophosphite, hydrazine, hydroxymethane sulfonate, and mixtures thereof. In preferred embodiments, the reducing agent includes iron powder and sodium hypophosphite. In any or all embodiments, the reducing agent is used in an amount from 0.01 kg to 50 kg of reagent per ton of P₂O₅, based on the type and quantity of the oxidants in the phosphoric acid solution, which can be readily determined by those skilled in the art using no more than routine methods. In preferred embodiments, the amount of reducing agent is from 0.1 kg to 5 kg of reagent per ton of P₂O₅ of the phosphoric acid solution.

Adsorbent agents can be useful in any or all embodiments according to the invention and include, but are not limited to, active charcoal/carbon, carbon black, ground lignite, adsorbents containing silicate (e.g., synthetic silicic acids, zeolites, calcium silicate, bentonite, perlite, diatomaceous earth, and fluorosilicate), calcium sulfate (including gypsum, hemihydrate, and anhydride), and mixtures thereof. In any or all embodiments, the adsorbent is present in an amount from 0.05 wt. % to 50 wt. %, and preferably from 0.1 wt. % to 30 wt. %, based on the quantity of phosphoric acid in the solution.

While various embodiments may have been described herein in singular fashion, those skilled in the art will recognize that any of the embodiments described herein can be combined in the collective. Indeed, the invention may be embodied in many different forms and should not be construed as limited to the embodiments set forth herein. Rather, these embodiments are provided so that this disclosure will satisfy applicable legal requirements.

In one aspect, the invention embodies compositions for forming complexes with heavy metal ions in a phosphoric acid containing stream, wherein the compositions comprise an effective amount of:
at least one dialkyldithiophosphate compound with the alkyl chain length of C8 to C18;
at least one dialkyldithiophosphinate compound, and
at least one surfactant.

In the same or other embodiments, the dialkyldithiophosphate compound with the alkyl chain length of C8 to C18 is selected from the group consisting of dialkyldithiophosphoric acid with the alkyl chain length of C8 to C18 and salts of any of the foregoing dialkyldithiophosphoric acid with the alkyl chain length of C8 to C18 in the form of calcium, magnesium, potassium, sodium salt or ammonium salt with the formula NR₁R₂R₃R₄⁺, where R₁, R₂, R₃, R₄ are, equal to or different from each other, independently chosen from hydrogen, alkyl or aryl groups; and mixtures thereof. In some embodiments, the alkyl chain of the dialkyldithiophosphate compound according to the invention is a C8 to C12 chain. Preferably, the alkyl chain of the dialkyldithiophosphate compound according to the invention is a C8 alkyl chain.

In the same or alternate embodiments, the dialkyldithiophosphate compound is selected from the group consisting of any salts of di(1,3-dimethylbutyl) dithiophosphoric acid, di(2-ethylhexyl) dithiophosphoric acid, di(3,7-dimethyloctyl) dithiophosphoric acid, di(2-butyloctanol) dithiophosphoric acid; and mixtures thereof, said salts being as defined previously. In a preferred embodiment, dialkyldithiophosphate compound are salts of di(2-ethylhexyl) dithiophosphoric acid, di(3,7-dimethyloctyl) dithiophosphoric acid, and di(2-butyloctanol) dithiophosphoric acid; and mixtures thereof. In a more preferred embodiment, the dialkyldithiophosphate compound is any salts of di(2-ethylhexyl) dithiophosphoric acid, preferably ammonium salt of di(2-ethylhexyl) dithiophosphoric acid.

In the same or alternate embodiments, the dialkyldithiophosphate compound is selected from the group consisting of di(1,3-dimethylbutyl) dithiophosphate, di(2-ethylhexyl) dithiophosphate, di(3,7-dimethyloctyl) dithiophosphate, di(2-butyloctanol) dithiophosphate; and mixtures thereof. In a preferred embodiment, dialkyldithiophosphate compound are di(2-ethylhexyl) dithiophosphate, di(3,7-dimethyloctyl) dithiophosphate, and di(2-butyloctanol) dithiophosphate. In a more preferred embodiment, dialkyldithiophosphate compound is di(2-ethylhexyl) dithiophosphate.

In the same of other embodiments, the dialkyldithiophosphinate compound is selected from the group consisting of dialkydithiophosphinic acid and any salts (e.g., calcium, magnesium, potassium, sodium) of the foregoing dialkyldithiophosphinic acid in the form of calcium, magnesium, potassium, sodium salt or ammonium salt with the formula NR₁R₂R₃R₄⁺, where R₁, R₂, R₃, R₄ are, equal to or different from each other, independently chosen from hydrogen, alkyl or aryl groups; and mixtures thereof.

In the same or alternate embodiments the dialkyldithiophosphinate compound is selected from the group consisting of salts of diisobutyl dithiophosphinic acid; bis(2,4,4-trimethylpentyl) dithiophosphinic acid; and mixtures thereof, said salts being as defined above. In a preferred embodiment, the dialkyldithiophosphinate compound is sodium diisobutyl dithiophosphinate.

In any of the foregoing or additional embodiments, the surfactant compound can be selected from the group consisting of sulfosuccinates; aryl sulfonates; alkaryl sulfonates; diphenyl sulfonates; olefin sulfonates; sulfonates of ethoxylated alcohols; petroleum sulfonates; sulfosuccinamates; alkoxylated surfactants; ester/amide surfactants; EO/PO block copolymers; and mixtures thereof.

In the same or alternate embodiment, the surfactant can be an alkaryl sulfonates. In a preferred embodiment, the surfactant can be an alkyldiphenyloxide disulfonate. Suitable alkyldiphenyloxide disulfonate compounds include, but are not limited to, DOWFAX® 8390 available from Dow Chemical. In the same or alternate embodiment, the surfactant can be a sulfosuccinate. Suitable sulfosuccinate can be sodium dioctylsulfosuccinate. Suitable sodium dioctylsulfosuccinate compounds include, but are not limited to, AEROSOL® OT-70 and DHAYSULF® 70B available from Solvay S.A. In the same or alternate embodiment, the surfactant can be an alkoxylated surfactant Suitable alkoxylated surfactants can include, but are not limited to, polyethyleneglycol sorbitan monooleate (such as TWEEN® 80 available from Croda), and polyethyleneglycol sorbitol hexaoleate (such as ATLAS® G1086 available from Croda).

In any of the foregoing or additional embodiments, the ratio of the sum of at least one dialkyldithiophosphate compound with the alkyl chain length of C8 to C18 and at least one dialkyldithiophosphinate compound to surfactant is from 1000:1 to 5:1. In a preferred embodiment, the ratio of the sum of at least one dialkyldithiophosphate compound with the alkyl chain length of C8 to C18 and at least one dialkyldithiophosphinate compound to surfactant is from 100:1 to 10:1.

In any or all embodiments, the ratio of at least one dialkyldithiophosphate compound with the alkyl chain length of C8 to C18 to at least one dialkyldithiophosphinate compound is from 1:100 to 100:1. In a preferred embodiment, the ratio of at least one dialkyldithiophosphate compound with the alkyl chain length of C8 to C18 to at least one dialkyldithiophosphinate compound is from 1:20 to 20:1. In a more preferred embodiment, the ratio of at least one dialkyldithiophosphate compound with the alkyl chain length of C8 to C18 to at least one dialkyldithiophosphinate compound is from 1:5 to 5:1.

In another aspect, the invention embodies processes for removing heavy metal ions from a phosphoric acid containing stream, wherein such processes comprise: adding an effective amount of a reagent, comprising a composition for forming complexes with heavy metal ions as disclosed and embodied herein, to the phosphoric acid containing stream to form heavy metal ion complexes, and separating the heavy metal ion complexes from the phosphoric acid containing stream.

In the same or other embodiment, the process is performed at a temperature from 0° C. to 120° C.; preferably from 20° C. to 80° C.

In any of the foregoing or additional embodiments, the phosphoric acid containing stream has a P₂O₅ concentration from 4% to 70%; typically from 25% to 60% concentrated P₂O₅.

In any of the foregoing or additional embodiments of the process, the process can further comprise adding an effective amount of a reducing agent to the phosphoric acid containing stream.

In the same or other embodiments, the reducing agent is selected from the group consisting of sodium hypophosphite, hydrazine, iron (II) sulfate, iron powder, and mixtures of any of the foregoing. In a preferred embodiment, the reducing agent is iron powder and sodium hypophosphite.

In any or all embodiments of the process, the reducing agent can be added prior to, or together with, the reagent.

In any of the foregoing or additional embodiments of the process, the process can further comprise adding an effective amount of an adsorbent to the phosphoric acid containing stream.

In the same or other embodiments, the adsorbent is selected from the group consisting of calcium sulfate, fluorosilicate, activated carbon, and mixtures of any of the foregoing.

In any of the foregoing or additional embodiments of the process, the process can comprise the step of filtering the phosphoric acid containing streams prior to adding the reagent.

In any of the foregoing or additional embodiments of the process, the at least one dialkyldithiophosphate compound with the alkyl chain length of C8 to C18, the at least one dialkyldithiophosphinate compound and the at least one surfactant of the reagent are added simultaneously, in the form of blend, to the phosphoric acid containing stream.

In any of the foregoing or additional embodiments, the heavy metal ions that are complexed by the reagent and removed by separation are selected from the group consisting of chromium, cadmium, arsenic, mercury, copper, lead, and mixtures of any of the foregoing. In a preferred embodiment, the heavy metal ions removed from the phosphoric acid containing stream comprise cadmium and/or arsenic and/or copper.

### EXAMPLES

The following examples are provided to assist one skilled in the art to further understand certain embodiments of the present invention. These examples are intended for illustration purposes and are not to be construed as limiting the scope of the various embodiments of the present invention, as defined by the claims.

The performances of blends of at least one dialkyldithiophosphate compound with the alkyl chain length of C8 to C18, at least one dialkyldithiophosphinate compound, and at least one surfactant to remove heavy metals are evaluated with phosphoric acid and phosphoric acid slurries. The phosphoric acids with different P₂O₅ levels are obtained from industrial phosphoric acid processing plants. The phosphoric acid slurries are generated by mixing plant gypsum solids with plant phosphoric acid. To separate the heavy metal precipitates from the acid, either a syringe filter or a vacuum filtration is used. Afterwards, the filtrate acids are analyzed with ICP (Inductively Coupled Plasma) to determine the level of various heavy metal elements. The general procedure for the test and experimental examples are outlined below.

The sodium diisobutyl dithiophosphinate (“Na-DTPi”), sodium diisobutyl dithiophosphate (“Na-C4DTP”) and the sodium dioctylsulfosuccinate (AEROSOL OT70PG—“Surfactant B”) are obtained from Solvay SA. The alkyldiphenyloxide disulfonate surface active solution (DOWFAX® 8390—“Surfactant A”) is purchased from Dow Chemicals. The polyethyleneglycol sorbitol hexaoleate (ATLAS® G1086—“Surfactant C”) is purchased from Croda. The dialkyldithiophosphate compounds with various chain lengths were synthesized in Solvay laboratories. The blend was prepared by combining the dialkyldithiophosphate compounds with various chain lengths, Na-DTPi (Sodium diisobutyl dithiophosphinate) and the surfactant.

The dialkyldithiophosphate compounds with various chain lengths were synthesized as explained in Example 1 below.

### Example 1—Preparation of the Dialkyldithiophosphate Compounds

### Example 1-A: Synthesis of Di(1,3-Dimethylbutyl) Dithiophosphoric Acid (“C6DTP”)

To a 250 ml 3-neck round bottom flask equipped with a heating mantle, magnetic stirring, nitrogen flow and vent to a caustic scrubber was added 150.20 g (1.4703 moles) of 1,3-dimethylbutanol (2 mole % excess). After heating to 40° C., 80.00 g of P₂S₅ (0.1802 moles) was added in three equal portions over 30 minutes with vigorous stirring. The reaction temperature was then increased to 80° C. where it was held for 4 hours. The reaction product was cooled and filtered to yield a light yellow, low viscosity liquid. (³¹P NMR δ 82 ppm, 86.3%).

### Example 1-B: Synthesis of Di(2-Ethylhexyl) Dithiophosphoric Acid (“C8DTP”)

To a 250 ml 3-neck round bottom flask equipped with a heating mantle, magnetic stirring, nitrogen flow and vent to a caustic scrubber was added 155.57 g (1.1946 moles) of 2-ethylhexanol (2 mole % excess). After heating to 40° C., 65.00 g of P₂S₅ (0.1464 moles) was added in three equal portions over 30 minutes with vigorous stirring. The reaction temperature was then increased to 80° C. where it was held for 4 hours. The reaction product was cooled and filtered to yield a light yellow, low viscosity liquid. (³¹P NMR δ 85 ppm, 85.4%).

### Example 1-C: Synthesis of Di(3,7-Dimethyloctyl) Dithiophosphoric Acid (“C10DTP”)

To a 250 ml 3-neck round bottom flask equipped with a heating mantle, magnetic stirring, nitrogen flow and vent to a caustic scrubber was added 159.99 g (1.0108 moles) of 3,7-dimethyloctanol (2 mole % excess). After heating to 40° C., 80.00 g of P₂S₅ (0.1239 moles) was added in three equal portions over 30 minutes with vigorous stirring. The reaction temperature was then increased to 80° C. where it was held for 4 hours. The reaction product was cooled and filtered to yield a light yellow, low viscosity liquid. (³¹P NMR δ 85 ppm, 86.1%).

### Example 1-D: Synthesis of Di(2-Butyloctyl) Dithiophosphoric Acid (“C12DTP”)

To a 250 ml 3-neck round bottom flask equipped with a heating mantle, magnetic stirring, nitrogen flow and vent to a caustic scrubber was added 162.21 g (0.8270 moles) of 2-butyloctanol (2 mole % excess). After heating to 40° C., 45.00 g of P₂S₅ (0.1014 moles) was added in three equal portions over 30 minutes with vigorous stirring. The reaction temperature was then increased to 80° C. where it was held for 4 hours. The reaction product was cooled and filtered to yield a light yellow, low viscosity liquid. (³¹P NMR δ 85.4 ppm, 88.9%).

### Example 1-E: Synthesis of Di(2-Hexyldecanyl) Dithiophosphoric Acid (“C16DTP”)

Di(2-hexyldecanyl) dithiophosphoric acid was synthesized by reacting P₂S₅ and 2-hexyl-1-decanol with the same process as discussed in the above examples.

### Example 1-F: Neutralization Process of Di(2-Ethylhexyl) Dithiophosphoric Acid with Ammonium Hydroxide for Preparing Ammonium Di(2-Ethylhexyl) Dithiophosphate (“C8DTP-NH₄”)

To a 250 ml 3-neck round bottom flask equipped with a heating mantle, magnetic stirring, and nitrogen flow was added 100.00 g g (0.2823 moles) of di(2-ethylhexyl) dithiophosphoric acid, as prepared in Example 1-C above. With vigorous agitation, 18.55 g of 28% aqueous ammonium hydroxide (2 mole % excess) was added to the reactor. An ice bath was raised and the addition rate was controlled to maintain the reaction temperature below 40° C. The reaction product was a light yellow, low viscosity liquid. (³¹P NMR δ 111 ppm, 93.1%).

### Example 2—Process for Removing Heavy Metals from Plant Phosphoric Acids #1 (~54% P₂O₅) at Elevated Temperature (72° C.)

50 g of plant phosphoric acid #1 (~54% P₂O₅, collected from the clarification tank after filtration) are transferred into a glass jar with a magnetic stir bar. The acid is heated to 72° C. in a water bath. An effective amount (as listed in Table 1) of a reagent of interest is dosed into plant phosphoric acid #1 under agitation at 350 rpm. After agitation for 1 minute and settlement for another minute, the acid is transferred into a syringe and filtered with a 0.2 μm polyvinylidene difluoride (PVDF) syringe filter. The filtrate is collected and then submitted for ICP elemental analysis.

The ICP results of the remaining Cd in filtered phosphoric acid and the corresponding calculated percentage of Cd removed are shown in Table 1. The lower the remaining Cd and the higher the percentage of Cd removed, the better the performance of reagents.

TABLE 1

| | Plant | | | | | | Percentage |
|---|---|---|---|---|---|---|---|
| | phosphoric | | | | | Treatment | of Cd |
| | acid # 1 | Temp. | | Dosage | Cd | Time | removed |
| Example | (~54% P₂O₅) | (° C.) | Reagents | (kg/T P₂O₅) | (ppm) | (min) | (%) |
| 2A-1 | #1 | ~72 | Control | 0 | 18.6 | — | 0 |
| 2A-2 | #1 | ~72 | Na-C4DTP | 3.0 | 15.2 | 1 | 18.3 |
| 2A-3 | #1 | ~72 | Na-C4DTP + | 3.0 | 10.8 | 1 | 41.9 |
| | | | Na-DTPi + | | | | |
| | | | Surfactant A | | | | |
| 2A-4 | #1 | ~72 | C6DTP + | 3.0 | 10.2 | 1 | 45.2 |
| | | | Na-DTPi + | | | | |
| | | | Surfactant A | | | | |
| 2A-5 | #1 | ~72 | C8DTP-NH₄ + | 3.0 | 5.1 | 1 | 72.6 |
| | | | Na-DTPi + | | | | |
| | | | Surfactant A | | | | |
| 2A-6 | #1 | ~72 | C10DTP + | 3.0 | 2.2 | 1 | 88.2 |
| | | | Na-DTPi + | | | | |
| | | | Surfactant A | | | | |
| 2A-7 | #1 | ~72 | C12DTP + | 3.0 | 2.6 | 1 | 86.0 |
| | | | Na-DTPi + | | | | |
| | | | Surfactant A | | | | |
| 2A-8 | #1 | ~72 | C16DTP + | 3.0 | 7.6 | 1 | 59.1 |
| | | | Na-DTPi + | | | | |
| | | | Surfactant A | | | | |
| 2A-9 | #1 | ~72 | C8DTP-NH₄ + | 3.0 | 16.0 | 1 | 14.0 |
| | | | Na-DTPi | | | | |

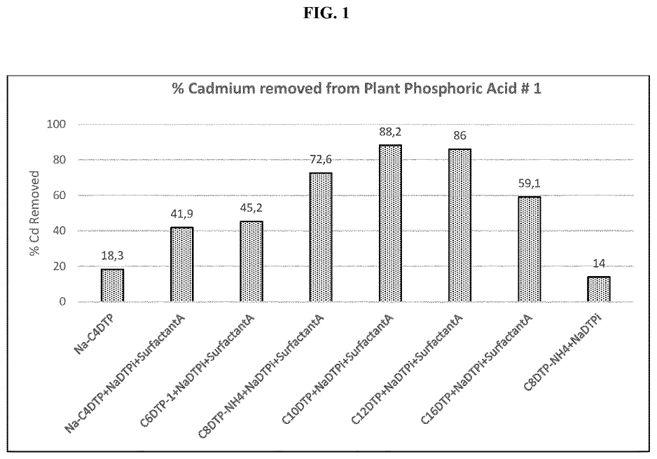

As indicated by the results in Table 1, high percentages of cadmium are removed when reagents including dialkyldithiophosphate compound with the alkyl chain length of C8 to C18, sodium diisobutyl dithiophosphinate (“Na-DTPi”), and surfactant A are used according to the process described, in particular with dialkyldithiophosphate compound having C8 to C12 alkyl chain. This data supports a synergistic effect when the compounds are used together. FIG. 1, which plots the data of examples 2A-1 to 2A-9, further illustrates the superior performance and synergistic effect achieved when the reagent includes dialkyldithiophosphate compound with the alkyl chain length of C8 to C18, sodium diisobutyl dithiophosphinate (“Na-DTPi”), and surfactant A.

### Example 3—Process for Removing Heavy Metals from Plant Phosphoric Acids #2 (~60% P₂O₅) at Elevated Temperature (72° C.)

50 g of plant phosphoric acid #2 (~60% P₂O₅, collected from the clarification tank after filtration) are transferred into a glass jar with a magnetic stir bar. The acid is heated to 72° C. in a water bath. An effective amount (as listed in Table 2) of a reagent of interest is dosed into phosphoric acid #2 under agitation at 350 rpm. After agitation for 1 minute and settlement for another minute, the acid is transferred into a syringe and filtered with a 0.2 μm polyvinylidene difluoride (PVDF) syringe filter. The filtrate is collected and then submitted for ICP elemental analysis.

The ICP results of the remaining Cd in phosphoric acid and the corresponding calculated percentage of Cd removed are shown in Table 2. The lower the remaining Cd and the higher the percentage of Cd removed, the better the performance of reagents.

TABLE 2

| | Plant | | | | | | % | | % | | % |
|---|---|---|---|---|---|---|---|---|---|---|---|
| | phosphoric | | | | Treatment | | of Cd | | of As | | of Cu |
| | acid # 2 | Temp. | | Dosage | Time | Cd | removed | As | removed | Cu, | removed |
| Example | (~60% P₂O₅) | (° C.) | Reagents | (kg/T P₂O₅) | (min) | (ppm) | (%) | (ppm) | (%) | (ppm) | (%) |
| 3A-1 | #2 | ~72 | Control | 0 | — | 32.4 | 0 | 18.7 | 0 | 28.1 | 0 |
| 3A-2 | #2 | ~72 | Na-C4DTP | 3.0 | 1 | 29.6 | 8.6 | 16.7 | 10.7 | 24.1 | 14.2 |
| 3A-3 | #2 | ~72 | Na-C4DTP + | 3.0 | 1 | 28.5 | 12 | 16 | 14.4 | 20.4 | 27.4 |
| | | | Na-DTPi + | | | | | | | | |
| | | | Surfactant C | | | | | | | | |
| 3A-4 | #2 | ~72 | C8DTP-NH₄ + | 3.0 | 1 | 21.1 | 34.9 | 13.7 | 26.7 | 14.6 | 48 |
| | | | Na-DTPi + | | | | | | | | |
| | | | Surfactant C | | | | | | | | |
| 3A-5 | #2 | ~72 | C8DTP-NH₄ + | 3.0 | 1 | 16.5 | 49.1 | 10.7 | 42.8 | 6.9 | 75.4 |
| | | | Na-DTPi + | | | | | | | | |
| | | | Surfactant A | | | | | | | | |
| 3A-6 | #2 | ~72 | C12DTP + | 3.0 | 1 | 15.2 | 53.1 | 7.4 | 60.4 | 9 | 68 |
| | | | Na-DTPi + | | | | | | | | |
| | | | Surfactant C | | | | | | | | |
| 3A-7 | #2 | ~72 | C16DTP + | 3.0 | 1 | 26.7 | 17.6 | 14.3 | 23.5 | 18.4 | 34.5 |
| | | | Na-DTPi + | | | | | | | | |
| | | | Surfactant A | | | | | | | | |

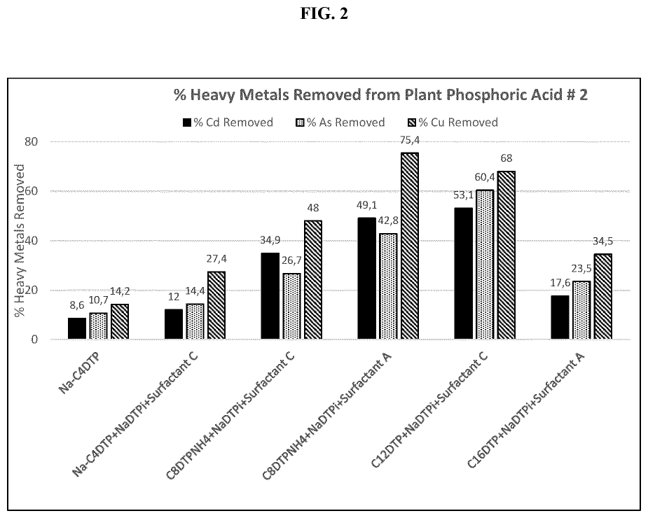

As indicated by the results in Table 2, high percentages of cadmium and/or arsenic and/or copper are removed when reagents including dialkyldithiophosphate compound with the alkyl chain length of C8 to C18, sodium diisobutyl dithiophosphinate (“Na-DTPi”), and surfactant are used according to the process described, in particular with dialkyldithiophosphate compound having C8 to C12 alkyl chain. This data supports a synergistic effect when the reagents according to the invention are used together, in particular with the surfactant A. FIG. 2, which plots the data of examples 3A-1 to 3A-7, further illustrates the superior performance and synergistic effect achieved when the reagent includes dialkyldithiophosphate compound with the alkyl chain length of C8 to C18, sodium diisobutyl dithiophosphinate (“Na-DTPi”), and surfactant.

### Example 4—Process for Measuring H₂S Off-Gassing from the Degradation of the Heavy Metals Removal Agents from Phosphoric Acid #3 (~30% P₂O₅) at ~72° C.

40 g of plant phosphoric acid #3 (~30% P₂O₅, collected from the clarification tank after filtration) were weighed into a glass jar with a magnetic stir bar and placed in a water bath at 75° C. on a submersible stirred plate. The glass jar was fitted with a lid having a port for capturing the headspace gasses in the glass jar. An effective amount (as listed in Table 3) of a reagent of interest is dosed into phosphoric acid #3 while stirring at 350 rpm. The jar was sealed and agitated for 5 minutes. Subsequently, the glass jar was removed from the water bath and allowed to cool for 5 minutes at room temperature. Afterwards the seal on the jar lid was pierced using a GASTEC H₂S sampling device and 100 ml of the headspace gasses were sampled. The amount of H₂S in the headspace was recorded directly from the calibrated sampling tubes.

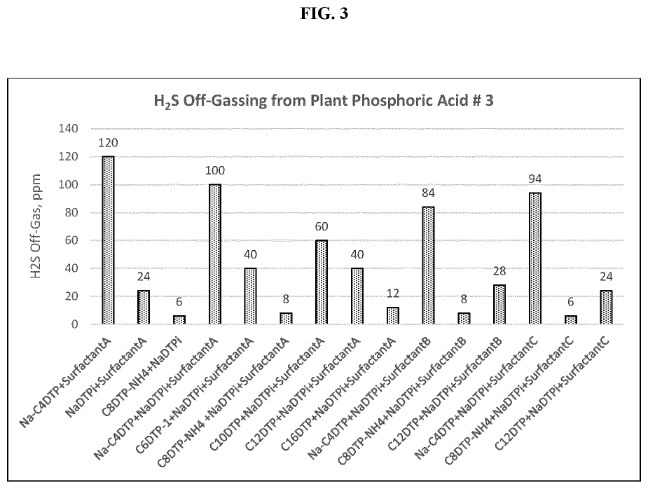

The results are shown in Table 3 and plotted in FIG. 3. The lower the H₂S off-gassing, the less the safety concerns to operators next to the acid stream.

TABLE 3

| | Plant | | | | | |
|---|---|---|---|---|---|---|
| | phosphoric | | | | Treatment | H₂S off- |
| | acid | Temp. | | Dosage | Time | gassing |
| Example | (~30% P₂O₅) | (° C.) | Reagents | (kg/T P₂O₅) | (min) | (ppm) |
| 4A | #3 | ~72 | Na-C4DTP + | 2 | 5 | 120 |
| | | | Surfactant A | | | |
| 4B | #3 | ~72 | Na-DTPi + | 2 | 5 | 24 |
| | | | Surfactant A | | | |
| 4D | #3 | ~72 | C8DTP-NH₄ + | 2 | 5 | 6 |
| | | | Na-DTPi | | | |
| 4E | #3 | ~72 | Na-C4DTP + | 2 | 5 | 100 |
| | | | Na-DTPi + | | | |
| | | | Surfactant A | | | |
| 4F | #3 | ~72 | C6DTP + | 2 | 5 | 40 |
| | | | NaDTPi + | | | |
| | | | Surfactant A | | | |
| 4G | #3 | ~72 | C8DTP-NH₄ + | 2 | 5 | 8 |
| | | | Na-DTPi + | | | |
| | | | Surfactant A | | | |
| 4H | #3 | ~72 | C10DTP + | 2 | 5 | 60 |
| | | | Na-DTPi + | | | |
| | | | Surfactant A | | | |
| 4I | #3 | ~72 | C12DTP + | 2 | 5 | 40 |
| | | | Na-DTPi + | | | |
| | | | Surfactant A | | | |
| 4J | #3 | ~72 | C16DTP + | 2 | 5 | 12 |
| | | | Na-DTPi + | | | |
| | | | Surfactant A | | | |
| 4K | #3 | ~72 | Na-C4DTP + | 2 | 5 | 84 |
| | | | Na-DTPi + | | | |
| | | | Surfactant B | | | |
| 4L | #3 | ~72 | C8DTP-NH₄ + | 2 | 5 | 8 |
| | | | Na-DTPi + | | | |
| | | | Surfactant B | | | |
| 4M | #3 | ~72 | C12DTP + | 2 | 5 | 28 |
| | | | Na-DTPi + | | | |
| | | | Surfactant B | | | |
| 4N | #3 | ~72 | Na-C4DTP + | 2 | 5 | 94 |
| | | | Na-DTPi + | | | |
| | | | Surfactant C | | | |
| 4O | #3 | ~72 | C8DTP-NH₄ + | 2 | 5 | 6 |
| | | | Na-DTPi + | | | |
| | | | Surfactant C | | | |
| 4P | #3 | ~72 | C12DTP + | 2 | 5 | 24 |
| | | | Na-DTPi + | | | |
| | | | Surfactant C | | | |

As indicated by the results in Table 3, we can observe a decrease of the amount of H₂S in the headspace when reagents including dialkyldithiophosphate compound with the alkyl chain length of C8 to C18, sodium diisobutyl dithiophosphinate (“Na-DTPi”), and surfactant are used according to the process described, especially in comparison with the blend comprising sodium diisobutyl dithiophosphate (“Na-C4DTP”), sodium diisobutyl dithiophosphinate (“Na-DTPi”), and surfactant. Thus, the use of the reagents according to the invention makes it possible to significantly reduce the H₂S off-gassing, while removing high percentages of cadmium and/or arsenic and/or copper. FIG. 3, which plots the data of examples 4A to 4P, further illustrates the superior performance achieved in term of reduction of H₂S off-gassing, when the reagent includes dialkyldithiophosphate compound with the alkyl chain length of C8 to C18, sodium diisobutyl dithiophosphinate (“Na-DTPi”), and surfactant.

### Example 5—Process for Measuring H₂S Off-Gassing from the Degradation of the Heavy Metals Removal Agents from Phosphoric Acid #4 (~30% P₂O₅) at ~72° C.

40 g of plant phosphoric acid #4 (~30% P₂O₅, collected from the clarification tank after filtration) were weighed into a glass jar with a magnetic stir bar and placed in a water bath at 75° C. on a submersible stirred plate. The glass jar was fitted with a lid having a port for capturing the headspace gasses in the glass jar. An effective amount (as listed in Table 4) of a reagent of interest is dosed into phosphoric acid #4 while stirring at 350 rpm. The jar was sealed and agitated for 5 minutes. Subsequently, the glass jar was removed from the water bath and allowed to cool for 5 minutes at room temperature. Afterwards the seal on the jar lid was pierced using a GASTEC H₂S sampling device and 100 ml of the headspace gasses were sampled. The amount of H₂S in the headspace was recorded directly from the calibrated sampling tubes.

The results are shown in Table 4. The lower the H₂S off-gassing, the less the safety concerns to operators next to the acid stream.

TABLE 4

| | Plant phosphoric | | | | Treatment | H₂S off- |
|---|---|---|---|---|---|---|
| | acid | Temp. | | Dosage | Time, | gassing, |
| Example | (~30% P₂O₅) | (° C.) | Reagents | (kg/T P₂O₅) | (min) | (ppm) |
| 5A-1 | #4 | ~72 | Na-C4DTP + | 0.9 | 5 | 85 |
| | | | Surfactant A | | | |
| 5B-1 | #4 | ~72 | C6DTP + | 1.79 | 5 | 70 |
| | | | Surfactant A | | | |
| 5C-1 | #4 | ~72 | Na-DTPi + | 1 | 5 | 28 |
| | | | Surfactant A | | | |
| 5D-1 | #4 | ~72 | C8DTP-NH₄ + | 1.63 | 5 | 10 |
| | | | Na-DTPi + | | | |
| | | | Surfactant A | | | |

As indicated by the results in Table 4, we can observe a high decrease of the amount of H₂S in the headspace when reagents including dialkyldithiophosphate compound with the alkyl chain length of C8 to C18, sodium diisobutyl dithiophosphinate (“Na-DTPi”), and surfactant are used together, according to the process described. This data supports synergistic effect when the reagents according to the invention are used together

### Example 6—Process for Measuring H₂S Off-Gassing from the Degradation of the Heavy Metals Removal Agents from Phosphoric Acid #5 (~57% P₂O₅) at ~72° C.

40 g of plant phosphoric acid #5 (~57% P₂O₅, collected from the clarification tank after filtration) were weighed into a glass jar with a magnetic stir bar and placed in a water bath at 75° C. on a submersible stirred plate. The glass jar was fitted with a lid having a port for capturing the headspace gasses in the glass jar. An effective amount (as listed in Table 5) of a reagent of interest is dosed into phosphoric acid #5 while stirring at 350 rpm. The jar was sealed and agitated for 5 minutes. Subsequently, the glass jar was removed from the water bath and allowed to cool for 5 minutes at room temperature. Afterwards the seal on the jar lid was pierced using a GASTEC H₂S sampling device and 100 ml of the headspace gasses were sampled. The amount of H₂S in the headspace was recorded directly from the calibrated sampling tubes.

The results are shown in Table 5. The lower the H₂S off-gassing, the less the safety concerns to operators next to the acid stream.

TABLE 5

| | Plant | | | | | |
|---|---|---|---|---|---|---|
| | phosphoric | | | | Treatment | H off- |
| | acid | Temp. | | Dosage | Time | gassing |
| Example | (~57% P₂O₅) | (° C.) | Reagents | (kg/T P₂O₅) | (min) | (ppm) |
| 6A | #5 | ~72 | Na-DTPi + | 2 | 5 | 52 |
| | | | Surfactant A | | | |
| 6B | #5 | ~72 | Na-C4DTP + | 2 | 5 | 240 |
| | | | Na-DTPi + | | | |
| | | | Surfactant A | | | |
| 6C | #5 | ~72 | C6DTP + | 2 | 5 | 66 |
| | | | Na-DTPi + | | | |
| | | | Surfactant A | | | |
| 6D | #5 | ~72 | C8DTP-NH₄ + | 2 | 5 | 20 |
| | | | Na-DTPi + | | | |
| | | | Surfactant A | | | |
| 6E | #5 | ~72 | C10DTP + | 2 | 5 | 110 |
| | | | Na-DTPi + | | | |
| | | | Surfactant A | | | |
| 6F | #5 | ~72 | C12DTP + | 2 | 5 | 50 |
| | | | Na-DTPi + | | | |
| | | | Surfactant A | | | |
| 6G | #5 | ~72 | C16DTP + | 2 | 5 | 76 |
| | | | Na-DTPi + | | | |
| | | | Surfactant A | | | |

As indicated by the results in Table 5, we can observe a high decrease of the amount of H₂S in the headspace when reagents including dialkyldithiophosphate compound with the alkyl chain length of C8 to C18, sodium diisobutyl dithiophosphinate (“Na-DTPi”), and surfactant are used according to the process described, especially in comparison with the blend comprising sodium diisobutyl dithiophosphate (“Na-C4DTP”), sodium diisobutyl dithiophosphinate (“Na-DTPi”), and surfactant. Thus, the use of the reagents according to the invention makes it possible to significantly reduce the H₂S off-gassing, while removing high percentages of cadmium and/or arsenic and/or copper.

### Example 7—Process for Measuring H₂S Off-Gassing from the Degradation of the Heavy Metals Removal Agents from Plant Phosphoric Acid Slurry #1 (~30% P₂O₅) at 72° C.

40 g of plant phosphoric acid slurry #1 (~30% P₂O₅, collected from the clarification tank after filtration) were weighed into a glass jar with a magnetic stir bar and placed in a water bath at 75° C. on a submersible stirred plate. The glass jar was fitted with a lid having a port for capturing the headspace gasses in the glass jar. An effective amount (as listed in Table 6) of a reagent of interest is dosed into phosphoric acid slurry #1 while stirring at 350 rpm. The jar was sealed and agitated for 5 minutes. Subsequently, the glass jar was removed from the water bath and allowed to cool for 5 minutes at room temperature. Afterwards the seal on the jar lid was pierced using a GASTEC H₂S sampling device and 100 ml of the headspace gasses were sampled. The amount of H₂S in the headspace was recorded directly from the calibrated sampling tubes.

The results are shown in Table 6. The lower the H₂S off-gassing, the less the safety concerns to operators next to the acid stream.

TABLE 6

| | Phosphoric | | | | Treatment | H₂S off- |
|---|---|---|---|---|---|---|
| | Acid Slurry | Temp. | | Dosage | Time | gassing |
| Example | (~30% P₂O₅) | (° C.) | Reagents | (kg/T P₂O₅) | (min) | (ppm) |
| 7A | #1 | ~72 | Na-C4DTP + | 2 | 5 | 85 |
| | | | Surfactant A | | | |
| 7B | #1 | ~72 | Na-C4DTP + | 2 | 5 | 80 |
| | | | Na-DTPi + | | | |
| | | | Surfactant A | | | |
| 7C | #1 | ~72 | Na-C4DTP + | 2 | 5 | 76 |
| | | | Na-DTPi + | | | |
| | | | Surfactant B | | | |
| 7D | #1 | ~72 | C8DTP-NH₄ + | 2 | 5 | 2.4 |
| | | | Na-DTPi + | | | |
| | | | Surfactant A | | | |
| 7E | #1 | ~72 | C8DTP-NH₄ + | 2 | 5 | 4 |
| | | | Na-DTPi + | | | |
| | | | Surfactant B | | | |
| 7F | #1 | ~72 | C12DTP + | 2 | 5 | 18 |
| | | | Na-DTPi + | | | |
| | | | Surfactant B | | | |

As indicated by the results in Table 6, we can observe a high decrease of the amount of H₂S in the headspace when reagents including dialkyldithiophosphate compound with the alkyl chain length of C8 to C18, sodium diisobutyl dithiophosphinate (“Na-DTPi”), and surfactant are used according to the process described, in particular when dialkyldithiophosphate compound has a C8 alkyl chain, and this especially in comparison with the blend comprising sodium diisobutyl dithiophosphate (“Na-C4DTP”), sodium diisobutyl dithiophosphinate (“Na-DTPi”), and surfactant. Thus, the use of the reagents according to the invention makes it possible to significantly reduce the H₂S off-gassing, while removing high percentages of cadmium and/or arsenic and/or copper.

Various patent and/or scientific literature references have been referred to throughout this application. The disclosures of these publications in their entireties are hereby incorporated by reference as if written herein. However, if a term in the present application contradicts or conflicts with a term in the incorporated reference, the term from the present application takes precedence over the conflicting term from the incorporated reference. In view of the above description and the examples, one of ordinary skill in the art will be able to practice the disclosure as claimed without undue experimentation.

While typical embodiments have been set forth for the purpose of illustrating the fundamental novel features of the present invention, the foregoing descriptions should not be deemed to be a limitation on the scope herein. Accordingly, various modifications, adaptations, and alternatives can occur to one skilled in the art without departing from the spirit and scope of the invention described herein, and the scope of the invention should be defined by the appended claims.

1. A composition for forming complexes with heavy metal ions in a phosphoric acid containing stream, wherein the composition comprises an effective amount of:
at least one dialkyldithiophosphate compound with an alkyl chain length of C8 to C18;
at least one dialkyldithiophosphinate compound, and
at least one surfactant.

2. The composition according to claim 1, wherein said dialkyldithiophosphate compound with the alkyl chain length of C8 to C18 is selected from the group consisting of dialkyldithiophosphoric acid with the alkyl chain length of C8 to C18 and salts of any of the foregoing dialkyldithiophosphoric acid with the alkyl chain length of C8 to C18 in the form of calcium, magnesium, potassium, sodium salt or ammonium salt with the formula NR₁R₂R₃R₄⁺, where R₁, R₂, R₃, R₄ are, equal to or different from each other, independently chosen from hydrogen, alkyl or aryl groups; and mixtures thereof.

3. The composition according to claim 1, wherein said at least one dialkyldithiophosphate compound has an alkyl chain of C8 to C12.

4. The composition according to claim 1, wherein said dialkyldithiophosphate compound has a C8 alkyl chain.

5. The composition according to claim 2, wherein said dialkyldithiophosphate compound is selected from the group consisting of salts of di(1,3-dimethylbutyl) dithiophosphoric acid, di(2-ethylhexyl) dithiophosphoric acid, di(3,7-dimethyloctyl) dithiophosphoric acid, di(2-butyloctanol) dithiophosphoric acid; and mixtures thereof.

6. The composition according to claim 5, wherein said dialkyldithiophosphate compound is salts of di(2-ethylhexyl) dithiophosphoric acid, or is ammonium di(2-ethylhexyl) dithiophosphate.

7. (canceled)

8. The composition according to claim 1, wherein said dialkyldithiophosphinate compound is selected from the group consisting of dialkydithiophosphinic acid and salts of any of the foregoing dialkyldithiophosphinic acid in the form of calcium, magnesium, potassium, sodium salt or ammonium salt with the formula NR₁R₂R₃R₄*, where R₁, R₂, R₃, R₄ are, equal to or different from each other, independently chosen from hydrogen, alkyl or aryl groups; and mixtures thereof, or is selected from the group consisting of salts of diisobutyl dithiophosphinic acid: bis(2,4,4-trimethylpentyl) dithiophosphinic acid; and mixtures thereof, or is sodium diisobutyl dithiophosphinate.

9. (canceled)

10. (canceled)

11. The composition according to claim 1, wherein said surfactant is selected from the group consisting of sulfosuccinates, aryl sulfonates, alkaryl sulfonates, diphenyl sulfonates, olefin sulfonates, sulfonates of ethoxylated alcohols, petroleum sulfonates, sulfosuccinamates, alkoxylated surfactants, ester/amide surfactants, EO/PO block copolymers, and mixtures thereof.

12. The composition according to claim 11, wherein said surfactant is an alkaryl sulfonate or is an alkyldiphenyloxide disulfonate.

13. (canceled)

14. The composition according to claim 11, wherein said surfactant is a sulfosuccinate or is a sodium dicotylsulfosuccinate.

15. (canceled)

16. The composition according to claim 11, wherein said surfactant is an alkoxylated surfactant or is a polethyleneglycol sorbitol hexaoleate.

17. (canceled)

18. The composition according to claim 1, wherein the ratio of the sum of at least one dialkyldithiophosphate compound with the alkyl chain length of C8 to C18 and at least one dialkyldithiophosphinate compound to surfactant is from 1000:1 to 5:1.

19. The composition according to claim 1, wherein the ratio of at least one dialkyldithiophosphate compound with the alkyl chain length of C8 to C18 to at least one dialkyldithiophosphinate compound is from 1:100 to 100:1.

20. A process for removing heavy metal ions from a phosphoric acid containing stream, said process comprising:
adding an effective amount of a reagent comprising a composition as defined in claim 1 to the phosphoric acid containing stream to form heavy metal ion complexes, and
separating the heavy metal ion complexes from the phosphoric acid containing stream.

21. The process according to claim 20, wherein the process is performed at a temperature from 0° C. to 120° C.

22. The process according to claim 20, wherein the phosphoric acid containing stream has a concentration from 4% to 70% P₂O₅.

23. The process according to claim 20, wherein the process further comprises adding an effective amount of a reducing agent to the phosphoric acid containing stream, wherein said reducing agent is selected from the group consisting of sodium hypophosphite, hydrazine, iron (II) sulfate, iron powder, and mixtures of any of the foregoing and/or further comprises adding an effective amount of an adsorbent to the phosphoric acid containing stream, wherein said adsorbent is selected from the group consisting of calcium sulfate, fluorosilicate, activated carbon, and mixtures of any of the foregoing.

24. (canceled)

25. The process according to claim 20, wherein the process further comprises filtering the phosphoric acid containing stream prior to adding the reagent.

26. The process according to claim 20, wherein the dialkyldithiophosphate compound with the alkyl chain length of C8 to C18, the dialkyldithiophosphinate compound and the surfactant are added in form of a blend to the phosphoric acid containing stream.

27. The process according to claim 20, wherein said heavy metal ions removed from the phosphoric acid containing stream are selected from the group consisting of chromium, cadmium, arsenic, mercury, copper, lead, and mixtures of any of the foregoing.

28. The process according to claim 27, wherein the heavy metal ions removed are cadmium or arsenic.

29. (canceled)
